(19) United States
(12) Patent Application Publication
(10) Pub. No.: US 2026/0119703 A1
(43) Pub. Date: Apr. 30, 2026

(54) Seri-Safe: Cloud Inventory

(71) Applicant: Clent Gilbert, Gary, IN (US)

(72) Inventor: Clent Gilbert, Gary, IN (US)

(21) Appl. No.: 18/932,668

(22) Filed: Oct. 31, 2024

(51) Int. Cl. G06F 21/62; G06F 21/32; G06F 21/60

(52) U.S. Cl. CPC G06F 21/6245; G06F 21/32; G06F 21/602; G06F 2221/2151

(57) ABSTRACT

The invention is a digital application called “Seri-Safe” designed to help users securely manage and track personal valuables. The app allows users to photograph items and store essential details such as description, serial number, model number, purchase date, and relevant remarks in a personal digital safe. This system facilitates quick and organized retrieval of item information, especially in cases of theft, loss, or damage caused by events like natural disasters. Seri-Safe enables users to generate and share itemized lists, which can be easily printed or emailed to law enforcement or insurance agencies, aiding in claims processes. The app simplifies asset management, providing a centralized, secure, and convenient platform for users to protect and keep track of their valuables, accessible via Google Play, App Store and web browser.

### COPYRIGHT NOTICE

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### BACKGROUND

### Field of the Invention

The invention relates to digital asset management systems, specifically focusing on an application that enables users to securely store, organize, and retrieve information about valuable personal items. This invention is particularly useful for documenting possessions for protection against theft, loss, or damage due to disasters, and for facilitating claims with law enforcement or insurance providers.

### Description of the Related Art

The need for efficient asset documentation has grown as individuals own increasingly valuable and diverse items, from electronics and jewelry to rare collectibles. However, traditional methods of managing information about these valuables, such as keeping physical receipts, paper lists, or spreadsheets, often fall short due to their vulnerability to loss, damage, and disorganization. In events such as theft, fires, floods, or other natural disasters, many individuals lack the precise and accessible information needed to substantiate insurance claims or report stolen items to law enforcement. Furthermore, the complexity and effort required to maintain accurate records often result in neglected or outdated documentation. Consequently, a systematic and secure approach to personal asset documentation is more necessary than ever.

Accurate and organized documentation of personal assets is essential for financial security, peace of mind, and swift recovery in case of unforeseen events. When items are lost or damaged, a documented record simplifies the process of proving ownership, value, and item specifics, which are critical for processing insurance claims and legal reporting. Without such records, individuals face significant obstacles, including prolonged claim delays, increased likelihood of denied claims, and, potentially, financial losses that insurance could have otherwise covered. The ability to produce a structured and detailed list of assets has become increasingly valuable, as insurance companies often require verified information before processing compensation. Additionally, well-documented records are crucial for avoiding disputes, both with insurers and law enforcement, in cases of high-value assets.

The impact of inadequate asset documentation is reflected in statistics that underscore the widespread nature of property loss and under-documented assets. According to the FBI, in the United States alone, victims of property crimes experience losses exceeding $15 billion annually. Further, studies by the Insurance Information Institute reveal that homeowners' and renters' insurance claims often face delays or denials due to insufficient documentation, with nearly one-third of claims requiring additional verification. Data also shows that less than half of Americans keep any form of asset inventory, and only about 40% of those individuals use digital systems to manage this information. Furthermore, digital solutions for asset management have seen a 20% increase in adoption annually, highlighting a growing demand for user-friendly, reliable systems that facilitate easy documentation, storage, and retrieval.

In recent years, a few companies and developers have attempted to address the need for personal asset management by creating apps and software for digital inventories. Some applications provide basic functionalities such as allowing users to upload images of items and save a description and value alongside it. Others include limited reporting capabilities, enabling users to generate and export itemized lists for insurance purposes. A few have integrated cloud storage to allow access across multiple devices, making them somewhat more accessible. Moreover, certain solutions offer rudimentary security measures, such as password protection, to prevent unauthorized access. While these features provide initial steps toward digital asset documentation, they typically lack the comprehensive functionality and robust security needed to fully address the demands of asset management, especially for valuable items that require high documentation standards.

Despite existing solutions, users continue to encounter multiple challenges in maintaining reliable, secure, and organized documentation of personal valuables. Many applications offer limited data input fields, restricting users to basic item descriptions without allowing them to capture more granular details, such as serial numbers, model numbers, and purchase dates. Additionally, inadequate security measures in most applications expose sensitive data to potential breaches, as they often rely on simple password protection rather than advanced encryption or biometric authentication. Furthermore, most tools lack metadata tagging and timestamping, which are essential for validating the authenticity and timing of records, and they do not integrate with insurance providers for streamlined claims processing. The absence of customizable, exportable reports also makes it challenging for users to provide itemized lists that meet insurance and law enforcement standards, resulting in a gap for a more sophisticated solution that offers a comprehensive, secure, and user-friendly approach to asset documentation.

The application was conceived to bridge the gaps left by current asset documentation solutions, combining advanced security, thorough documentation fields, and convenient accessibility. This app functions as a digital asset management tool that enables users to securely record, store, and retrieve detailed information about personal valuables. Seri-Safe provides an intuitive interface that guides users through the process of documenting items by capturing photos, entering specific details (such as item description, serial number, model number, and date of purchase), and saving all information in a securely encrypted Digital Vault. Each recorded item is stored with a timestamp, verifying the date and time of documentation, and metadata tagging is available for categorizing items by attributes such as type, date, or value. Additionally, Seri-Safe is designed for portability and access across devices, offering a synchronized cloud-based platform that ensures data remains secure and accessible whenever needed.

The proposed application effectively fills the market gap by providing a complete and secure solution that addresses the limitations found in existing asset documentation tools. With its advanced security features, including end-to-end encryption and biometric authentication, Seri-Safe ensures that users' data remains protected against unauthorized access. The app's insurance integration capabilities allow users to link each item directly to the relevant insurance policy, facilitating a seamless process for claims submission. Additionally, Seri-Safe's robust reporting and sharing functions enable users to create itemized lists in a variety of formats suitable for both insurance claims and law enforcement reports, meeting high standards of documentation. This functionality eliminates the need for external report formatting and provides users with a comprehensive asset management solution that is secure, detailed, and convenient.

The innovation lies in its ability to offer a feature-rich, all-in-one asset management solution that addresses real-world needs with unparalleled security and ease of use. Compared to other tools, Seri-Safe stands out due to its layered security, customizable data, timestamping for data verification, and integration with insurance providers. Moreover, Seri-Safe's intuitive design and guided tutorials ensure that users of all tech skill levels can effectively document and manage their assets. Unlike many competitors, Seri-Safe goes beyond basic data, enabling users to generate reports, securely share records with third parties, and maintain a robust history of asset documentation in one convenient platform. This combination of features establishes Seri-Safe as a leader in the field of digital asset documentation, setting a new standard for security, usability, and comprehensiveness.

The proposed application is a well-rounded solution designed to meet the modern-day requirements of asset documentation, security, and accessibility. By addressing the current gaps and shortcomings in the market, Seri-Safe provides a secure, organized, and user-friendly platform for individuals looking to manage personal assets effectively. Future plans include potential enhancements, such as integration with valuation databases to estimate current market values and advanced AI-driven search functionalities to further streamline the retrieval of asset information. As the landscape of asset documentation evolves, Seri-Safe aims to adapt and expand its features, continuing to meet the demands of users in an increasingly digital and security-conscious world.

None of the previous inventions and patents, taken either singly or in combination, is seen to describe the instant invention as claimed. Hence, the inventor of the present invention proposes to resolve and surmount existent technical difficulties to eliminate the aforementioned shortcomings of prior art.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The present invention seeks to improve upon prior techniques and provide an advanced design and methodology of cloud-based data management.

It is the objective of the invention to provide users with a secure and encrypted digital vault for storing comprehensive records of personal valuables, ensuring data safety against unauthorized access.

It is a further objective of the present invention to facilitate easy retrieval of asset information through metadata tagging and search features, allowing users to categorize and locate items quickly based on specific attributes.

It is also an object of the invention to enhance reporting capabilities by enabling users to generate customized, exportable reports that meet insurance and law enforcement standards, thus simplifying claim and recovery processes.

It is further the objective of the invention to offer advanced data-sharing options that allow users to selectively share itemized lists and reports with external parties, such as insurance agents or law enforcement, in both digital and print formats.

It is also the objective of the invention to support insurance integration by allowing users to link valuables to relevant insurance policies, enabling fast, accurate, and verifiable documentation during claim processes.

It is also the objective of the invention to authenticate stored item information with metadata timestamping, verifying the date and time each item was recorded and ensuring trustworthy, tamper-proof records.

It is also the objective of the invention to improve user engagement and data accuracy by incorporating notifications that remind users to review and update their asset records periodically, maintaining relevance and completeness.

It is further the objective of the invention to ensure cross-device accessibility by providing cloud-based synchronization that allows users to securely access their records from multiple devices, enhancing flexibility and reliability.

It is also the objective of the invention to protect user data with biometric security options and encrypted storage, ensuring the highest level of security for sensitive information about users' valuables.

This Summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The present invention relates to a digital asset management software, herein referred to as “Seri-Safe,” which provides users with a secure, organized, and accessible means of recording, storing, and retrieving information about personal valuables. The application is handy for individuals seeking a method to document items in the event of theft, loss, or damage, and to simplify claim processes with insurance or law enforcement. By offering a structured interface, secure storage, and exportable reporting options, the application supports users in maintaining a precise digital record of their valuables.

As per its preferred embodiments, the invention is to provide an efficient method for documenting and storing data related to personal assets, including but not limited to images, serial numbers, model numbers, purchase dates, and descriptions. Additionally, the invention seeks to furnish users with features that enhance organization, security, and accessibility. This invention addresses the challenges of traditional record-keeping methods, enabling users to generate and share itemized lists quickly, which are essential for insurance and law enforcement purposes.

As per its preferred embodiments, the invention comprises three core components: a Digital Vault, a Data Input Interface, and Reporting and Sharing Capabilities. The Digital Vault serves as the secure repository for all recorded data, protected through encryption and biometric access options. The Data Input Interface is a streamlined system allowing users to input data associated with valuables, including visual and textual information. The Reporting and Sharing Capabilities enable users to export, print, or share itemized reports. Together, these components provide a comprehensive solution for asset management and retrieval.

As per its preferred embodiments, the Digital Vault within Seri-Safe functions as an encrypted database that securely stores user-entered information. Each item entered by the user is protected through end-to-end encryption, ensuring data privacy and preventing unauthorized access. The vault can be configured to support biometric authentication (such as fingerprint or facial recognition) as an optional layer of security. Furthermore, cloud-based capabilities are incorporated, allowing synchronized access from multiple devices through secure authentication protocols. Periodic data backups ensure data integrity and prevent loss in the event of device failure.

As per its preferred embodiments, the Data Input Interface allows users to enter data in a structured and efficient manner. The interface prompts users to capture photographs of each valuable item and its corresponding receipt, if available, and input details such as item description, serial number, model number, and date of purchase. A separate field for additional remarks enables users to add distinguishing information or notes about each item. Items can also be categorized through metadata tags, enhancing searchability by attributes such as type, purchase date, or value. This interface optimizes data entry and retrieval for rapid and comprehensive documentation.

The application includes a robust reporting system that enables users to generate customized reports of stored valuables. Reports can be tailored according to user-defined filters, such as category, date, or specific items. The application offers multiple export options, allowing users to share reports digitally through email or download them in formats such as PDF. These reports are designed to meet the documentation requirements of insurance providers and law enforcement, facilitating a seamless process for users needing to submit itemized lists in cases of theft or loss.

The system includes advanced functionalities that extend the core capabilities of the app. An Insurance Integration Feature enables users to link specific items to associated insurance policies, ensuring quick access to policy details and facilitating expedited claims. A Metadata Timestamping Feature further enhances the reliability of stored information by embedding timestamps within item metadata, thereby verifying the date and time each item was documented. These features collectively improve the utility of Seri-Safe as a trustworthy tool for asset protection.

To maintain user engagement and accuracy of records, the application is equipped with a notification system that prompts users to review and update their stored information at regular intervals. The app's user-friendly design guides users through each step of the documentation process, from initial data entry to report generation. An in-app tutorial provides instructions on using each feature effectively, ensuring users are able to leverage the app's full functionality. This guided experience is designed to reduce user errors and enhance the quality and reliability of stored data.

The application is accessible on mobile devices via Google Play and the App Store, offering broad compatibility and convenience for users. Once installed, the app allows users to set up a secure account with synchronized access across devices, supported by cloud-based storage and encryption. This cross-device compatibility ensures that users can access and manage their valuables from any authorized device, providing flexibility and reliability in asset documentation. By integrating secure access with cloud functionality, the application provides a comprehensive, portable, and secure solution for personal asset management.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

We claim:

1. A digital asset management system comprising:
A mobile application configured to store user-uploaded images and descriptions of personal valuables,
Means for associating each stored image with descriptive information, including item description, serial number, model number, date of purchase, and additional remarks,
A secure digital repository accessible by the user to retrieve and manage their stored items, wherein each item is protected by an encryption mechanism.
The system of claim 1, wherein the mobile application includes a notification system to remind users to update or review their stored valuables periodically.
The system of claim 1, wherein the item information includes metadata tags that facilitate easy retrieval based on categories, dates, or specific item attributes.
The system of claim 1, wherein the digital repository is cloud-based, enables users to access their stored information from multiple devices with secure authentication.

2. The system of claim 1, further comprising:
A feature to allow users to generate, export, and share an itemized list of stored valuables in digital format,
Means for selectively sharing item information with external entities, such as law enforcement or insurance providers, via email or printable formats.
The system of claim 2, wherein the application enables users to add insurance policy details associated with specific items for quick access in case of claims.
The system of claim 2, wherein a verification feature is incorporated to confirm the authenticity of item images through metadata or time-stamping.

3. A method for tracking and managing personal valuables, comprising:
The steps of capturing images of items and corresponding receipts, entering associated details (description, serial number, etc.), and saving the information to a secure, personal digital safe;
The method further comprising generating a report for selected or all items and exporting the report for external use.
The method of claim 3, further comprising an in-app guide or tutorial for users to streamline the process of documenting and categorizing personal items.
The method of claim 3, further comprising the use of biometric authentication to access the digital safe, ensuring heightened security of stored personal information.
